(19) United States
(12) Patent Application Publication
(10) Pub. No.: US 2014/0195926 A1
(43) Pub. Date: Jul. 10, 2014

(54) SYSTEMS AND METHODS FOR ENABLING ACCESS TO ONE OR MORE APPLICATIONS ON A DEVICE

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/736,123

(22) Filed: Jan. 8, 2013

(51) Int. Cl. G06F 3/0488

(52) U.S. Cl. CPC G06F 3/0488
USPC 715/750

(57) ABSTRACT

A method for enabling users to access multiple application programs contained in multiple application trays is provided. The method includes receiving a first touch sensitive input from one of the users for accessing one of the application trays associated with the user if the application tray is hidden from view on the display screen, wherein the first input includes the user's pulling the application tray handle until the application tray becomes fully visible on the display screen. The method also includes receiving a second touch sensitive input from the user for starting an application program, wherein the second input includes one of the user's pulling out of the application tray an application icon associated with the application program or the user's touching the application icon. The method further includes, in response to the second input, generating and displaying a window for providing a user interface for the application program.

### CROSS REFERENCE TO RELATED APPLICATIONS

This application is related to the following applications:

U.S. patent application Ser. No. 13/690,899, entitled “Systems and Methods for Changing Orientation of Display Windows and Contents;”

U.S. patent application Ser. No. 13/691,004, entitled “Systems and Methods for Controlling a User's Ability to Browse the Internet;”

U.S. patent application Ser. No. 13/691,077, entitled “Systems and Methods for Authenticating Users by Receiving Input from Multiple Devices.”

U.S. patent application Ser. No. 13/691,092, entitled “Systems and Methods for Selectively Delivering Messages to Multiuser Touch Sensitive Display Devices;”

U.S. patent application Ser. No. 13/691,162, entitled “Systems and Methods for Processing Simultaneously Received User Inputs;” and

U.S. patent application Ser. No. 13/691,188, entitled “Apparatus and Methods for Mounting a Multiuser Touch Sensitive Display Device.”

### FIELD OF INVENTION

The subject matter generally relates to the field of computing devices, and more particularly but not exclusively to accessing applications in computing devices.

### DISCUSSION OF RELATED FIELD

Modern computing devices are configured to execute several software applications. These applications can be accessed by a user in different ways. In one approach, icons corresponding to the applications are displayed on a screen. The user can click on the icon to execute the respective application. In this approach, the user is compelled to have all the icons on the screen to enable easy access to the application, which results in undesirable user experience.

In light of the foregoing discussion, there is a need for a technique to efficiently access the applications and effectively use the screen space on the computing device.

### SUMMARY

In an embodiment, a system for enabling access to one or more applications on a device is provided. The system includes a plurality of application trays. Each of the application trays is configured to accommodate one or more icons corresponding to the applications, hide the application tray and display at least one icon accommodated in the application tray upon receiving an input from a user.

In another embodiment, a method for enabling access to one or more applications on a device is provided. The method includes providing a plurality of application trays in the device. Each of the application trays is configured to accommodate one or more icons corresponding to the applications, hide the application tray and display at least one icon accommodated in the application tray upon receiving an input from a user.

In a multiuser touch sensitive screen display device including a touch sensitive display screen capable of receiving touch sensitive inputs from a plurality of users and displaying a plurality of application trays each tray having a tray handle, each tray associated with one of the plurality of users and each tray containing a plurality of application icons representing corresponding application programs, each application icon, when activated by one of the plurality of users, initiates an execution of a corresponding application program, wherein the multiuser touch sensitive screen display device can display a plurality of windows each window providing a user interface for a user to interact with an application program and wherein, when an application tray is hidden from view on the display screen, only the tray handle of the application tray is displayed on the display screen, a method is provided for enabling one or more of the plurality of users to access a plurality of application programs contained in one or more of the application trays.

The method includes: receiving a first touch sensitive input from one of the plurality of users for accessing one of the plurality of application trays associated with the one user if the selected application tray associated with the user is hidden from view on the display screen, wherein the first touch sensitive input includes the user's pulling the associated application tray handle until the selected application tray becomes fully visible on the display screen; displaying a plurality of application icons contained in the associated application tray; receiving a second touch sensitive input from the user for starting a selected application program, wherein the second touch sensitive input includes one of the user's pulling out of the application tray an application icon associated with the selected application program or the user's touching the associated application icon; and in response to the second touch sensitive input, generating and displaying a window for providing a user interface for the selected application program, wherein the window is used to received user inputs and display outputs for a running instance of the selected application.

### BRIEF DESCRIPTION OF DRAWINGS

Embodiments are illustrated by way of example in the Figures of the accompanying drawings, in which like references indicate similar elements and in which:

FIG. 1 is an example device 102 configured to allow access to applications through a user interface 106, in accordance with an embodiment;

FIG. 2 illustrates an application tray 202, in accordance with an embodiment;

FIG. 3 illustrates multiple application trays 202 provided in the device 102, in accordance with an embodiment;

FIG. 4 illustrates an example of applications 208 and 224 being launched, in accordance with an embodiment;

FIG. 5 is an example flowchart of a method 500 for allowing one or more users to access one or more applications on a single device, in accordance with an embodiment;

FIG. 6 illustrates an example application tray 202, in accordance with an embodiment; and

FIG. 7 illustrates active applications, which are shrunk, upon receiving the input from the user, in accordance with an embodiment;

FIG. 8 illustrates an example lock screen 800 on a user interface 104, in accordance with an embodiment; and

FIG. 9 illustrates another example lock screen 800 on the user interface 104, in accordance with an embodiment.

### DETAILED DESCRIPTION

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures, components and networks have not been described in detail so as not to unnecessarily obscure aspects of the embodiments. The embodiments can be combined, other embodiments can be utilized or structural and logical changes can be made without departing from the scope of what is claimed. The following detailed description is, therefore, not to be taken as a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

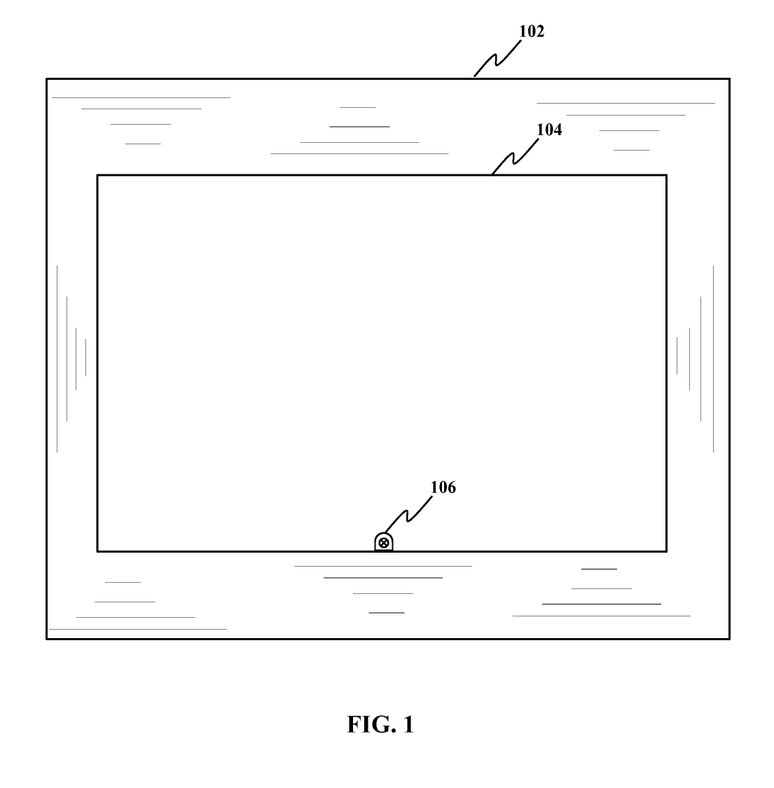

Embodiments disclose technique to access one or more applications on a device. Referring to FIG. 1, wherein FIG. 1 is an example device 102 configured to allow access to applications through a user interface 104, in accordance with an embodiment. The device 102 includes the user interface 104. The user interface 104 allows access to one or more applications through an application tray. FIG. 1 illustrates a handle 106 corresponding to the application tray. A user can access the application tray, thereby the applications, by providing input to the device 102.

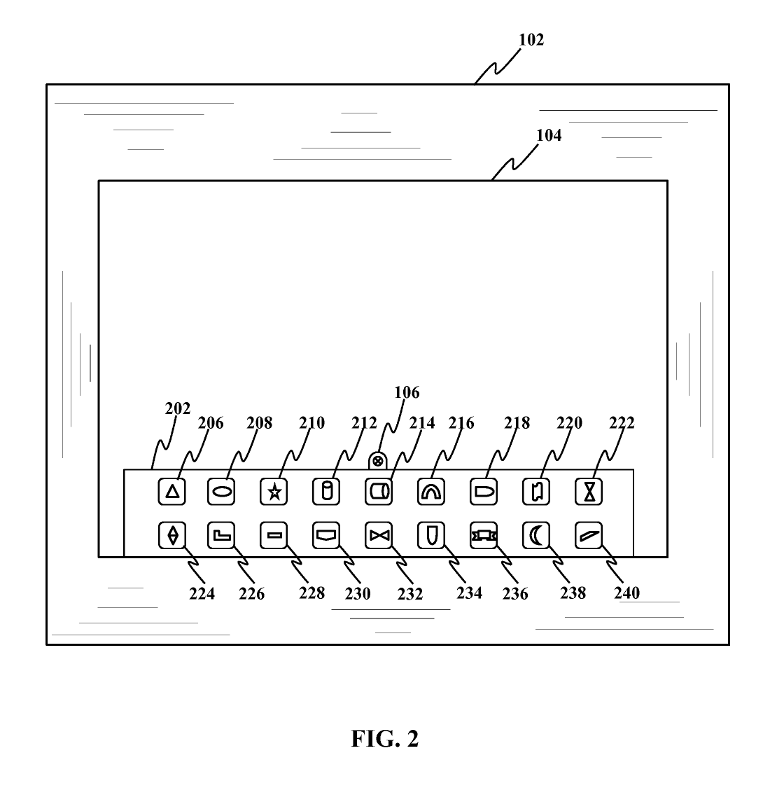

FIG. 2 illustrates an application tray 202, in accordance with an embodiment. A user can provide input to the device 102 so that the application tray 202 is displayed on the user interface 104. The input can be provided by pulling the handle 106 that corresponds to the application tray 202. Likewise, the handle 106 can be pushed back, so that the application tray 202 is not displayed on the user interface 104. The input can be in the form of a touch input or a gesture input. The touch input, for example, can be provided using a stylus or human touch. Other input means, such as a mouse, touchpad and keyboard can be used to provide inputs.

In an embodiment, the application tray 202 accommodates icons 206 to 240 corresponding to the applications. The application tray 202 at a given instance can accommodate zero or more icons. In an embodiment, the application tray 202 can accommodate icons corresponding to applications in one or more rows. In an embodiment, the application tray 202 can accommodate icons in one or more columns. In an embodiment, the application tray 202 can accommodate icons in a random pattern without following a pattern of rows and columns.

In an embodiment, additional rows of icons can be added to the application tray 202. In an embodiment, additional columns of icons can be added to the application tray 202. In an embodiment, the size of the application tray 202 can be modified. In an embodiment, the height of the application tray 202 can be modified. In an embodiment, the width of the application tray 202 can be modified.

In an embodiment, wherein the number of icons displayed in the user interface 104 is less than the actual number of icons in the application tray 202, the remaining icons which are not displayed on the user interface can be searched by receiving an input to display one or more of the remaining applications. In the instant embodiment, the input provided by the user to display one or more remaining icons can include gesture inputs such as up, down, left or right swiping of fingers, keyboard and mouse inputs, among other inputs to view additional icons.

In an embodiment, the application tray 202 can include features including, but not limited to, searching applications, categorizing applications, sorting applications based on various parameters, adding new applications, deleting one or more applications, updating applications and grouping one or more applications, among others.

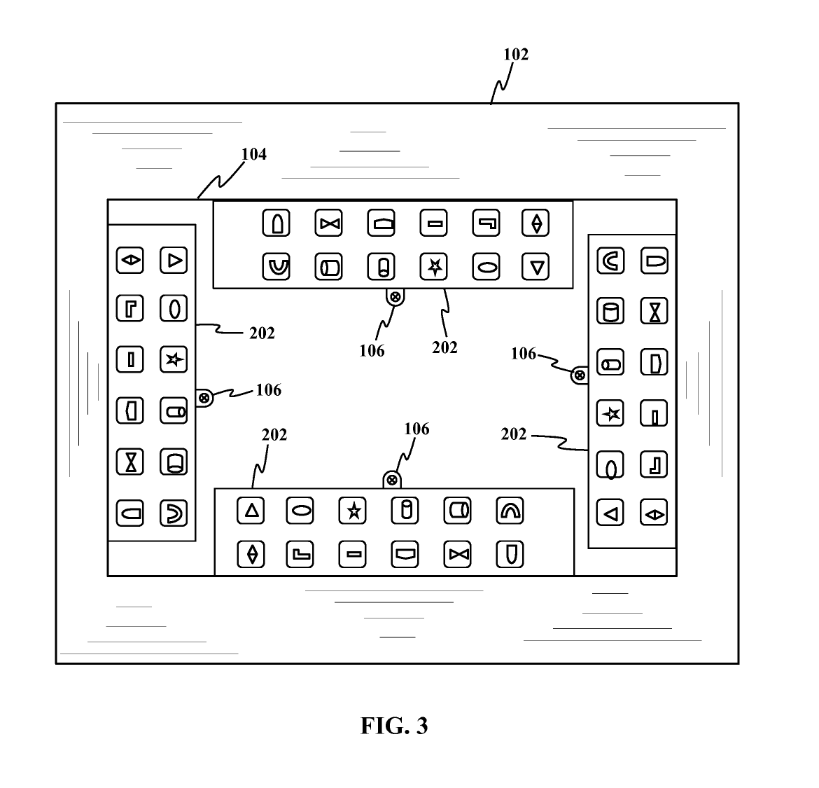

FIG. 3 illustrates multiple application trays 202 provided in the device 102, in accordance with an embodiment. In the instant illustration, four application trays 202 are illustrated. Each of the application trays 202 can be accessed by different users to access one or more applications whose icons are accommodated in the application trays 202. Hence, multiple users can access the same device 102 to access applications whose icons are accommodated in the application trays 202, and also customize the application trays 202.

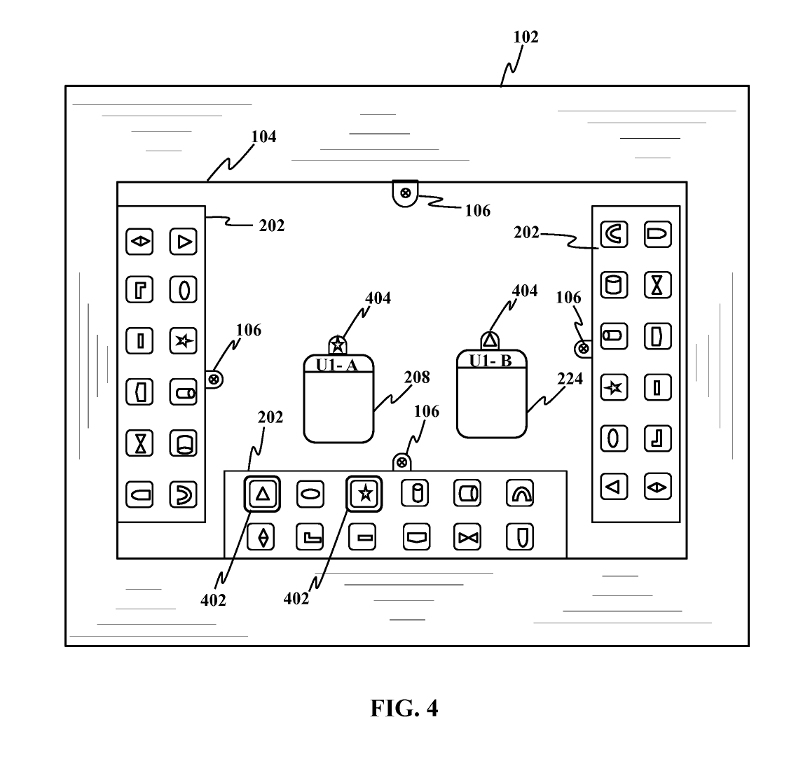

FIG. 4 illustrates an example of applications 208 and 224 being executed, in accordance with an embodiment. An application can be launched, for example, by touching the respective icon in the application tray 202 or by dragging the icon out of the application tray 202.

In an embodiment, the executed application can be terminated by using input devices or gestures, including but not limited to, single or multiple touches, dragging the applications into the application tray 202 using one or more fingers, mouse, touch pad on the display device and virtual touch pad provided on the user interface, among others gestures or input devices.

In an embodiment, multiple users can execute and access applications 206-240 corresponding to application tray 202. In an embodiment, an indication, such as indication 402 can be provided in the application tray 202 to indicate that the corresponding applications are being executed. In an embodiment, the user can move the executed applications 208 and 224 on the user interface 104 by holding an executed application handle 404 corresponding to the executed applications 208 and 224.

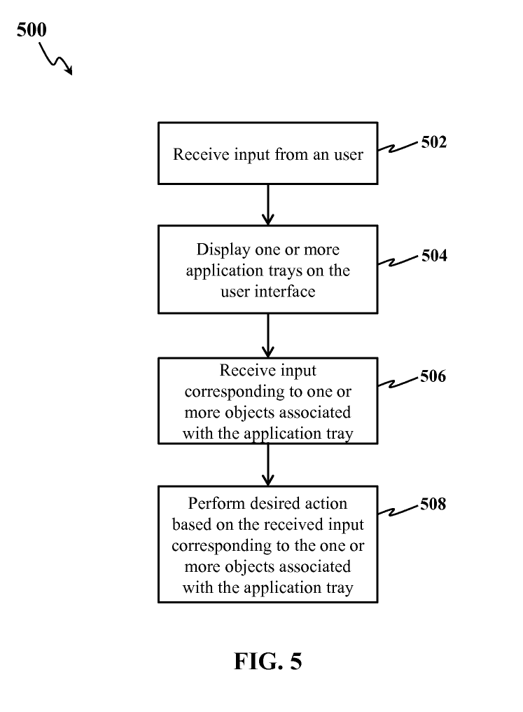

FIG. 5 is an example flowchart of a method 500 to allow one or more users to access one or more applications on a single device 102, in accordance with an embodiment. At step 502, the device 102 receives an input from the user. For example, when a user touches a handle 106, the device 102 can receive this input and perform the desired action. At step 504, the device 102 after receiving the input from the user displays one or more application trays 202 on the user interface 104. This step can also include performing an animation to display the application tray 202 on the user interface 104. The application tray 202 can include one or more application icons 206-240, which can further be rearranged according to the user's interest.

At step 506, the display device 102 is configured to receive input corresponding to one or more icons associated with the application trays 202. For example, the user can touch or click one or more icons 206-240 displayed in the application tray 202, or the user can navigate through the application tray 202 to view icons accommodated in the application tray 202.

At step 508, based on the input received from the user at step 506, the desired action is carried out by the device 102. This desired action, for example, can include, executing a sequence of instructions to open the selected application by the user, performing an animation to display more applications if the users input is clicking or touching the navigation button, filtering the applications 206-240 in the application tray 202 based on the search input and rearranging, sorting and deleting the applications 206-240 based on the input, among other actions.

In an embodiment, the inputs in the method 500 can be provided through any know input device, including but not limited to, keyboard, mouse, touch pad, track ball, touch screen, virtual keyboard provided on the user interface 106, one or more gestures using one or more fingers and a combination thereof. In an embodiment, application tray 202 is configured to receive user's authentication details. Subsequent to successful authentication, icons corresponding to applications associated with the user are displayed in the application tray 202.

In an embodiment wherein multiple devices 102 are networked, a user can access applications across the devices 102, through the application tray 202 provided in each of the devices 102, upon successful authentication. In an embodiment, the method 500 further includes an additional step of registering a user through a dedicated login interface. The login interface can be provided on the user interface 104.

In an embodiment, the method 500 further includes an additional step of creating a visible distinction between at least two application trays 202 displayed on the user interface 104. In an embodiment, the method 500 further includes an additional step of creating a visible distinction between the executed applications 206-240 of at least two application trays 202 displayed on the user interface 104. In an embodiment, the visible distinction can be any major or minor changes, including but not limited to, color coding the application tray, design and layout changes, using one or more alphabets, numbers, special characters and a combination thereof, among others.

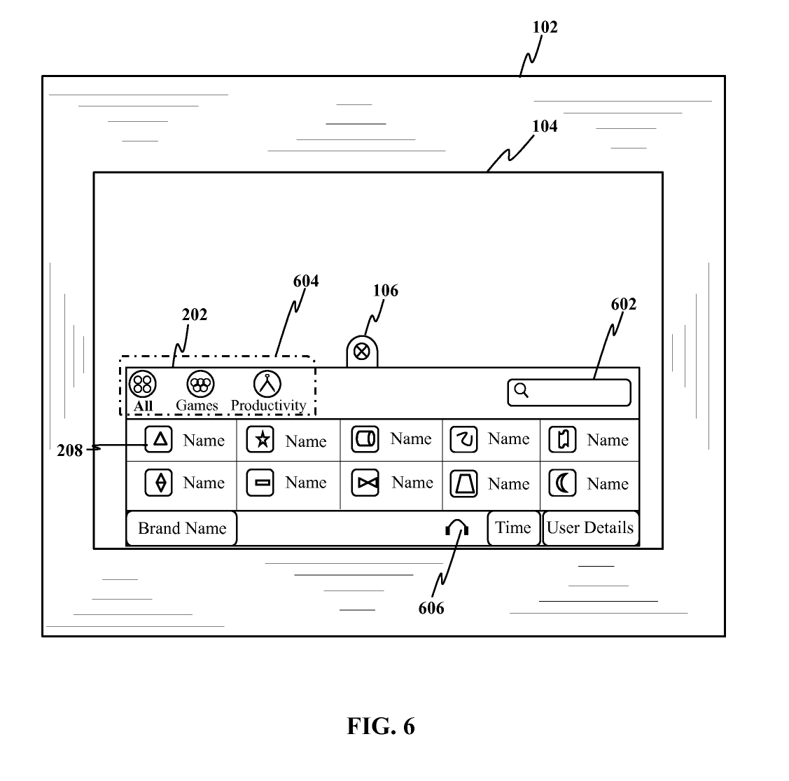

FIG. 6 illustrates an example application tray 202 on the device 102, in accordance with an embodiment. The application tray 202 can display one or more applications 206-240 along with their names as shown in the FIG. 6. Further, it can allow the user to organize the applications based on one or more categories 604. Furthermore, the application tray can suggest the user to use the headphones or earphones 606 based on the application executed by the user, or indicate the user about the status of the headphones or earphones 606. Additionally, the application tray can also include features, including but not limited to, allowing the user to search 602 applications and related data, display time, display user details, display location, brand name and business type, among others.

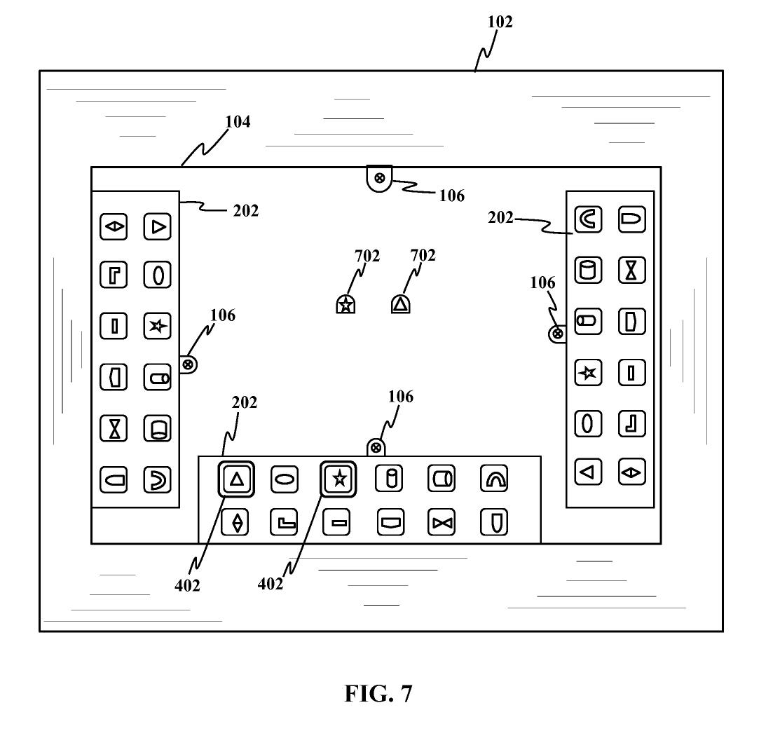

FIG. 7 illustrates shrunk applications 702, which are executed by receiving the input from the user, in accordance with an embodiment. When one or more applications 208 and 224 are executed as shown in the FIG. 4, the device 102 can shrink the executed applications 208 and 224 by receiving an input from the user. In the instant embodiment, the input received from the user can be in the form of double clicking an executed application handle 404 or performing one or more gestures, among others. In an embodiment, the user is allowed to group one or more executed applications by drawing a closed boundary around one or more executed applications. Further, the device 102 can ungroup the grouped applications and place the executed applications back in their previous positions, on the user interface 104 by receiving one or more inputs from the user.

In an embodiment, the user can lock the user interface 104 through the application tray 202. In an embodiment, the user can lock a part of the user interface 104 through the application tray 202. In an embodiment, the user can lock the application tray 202. Further, all the executed applications associated with the application tray may also be locked.

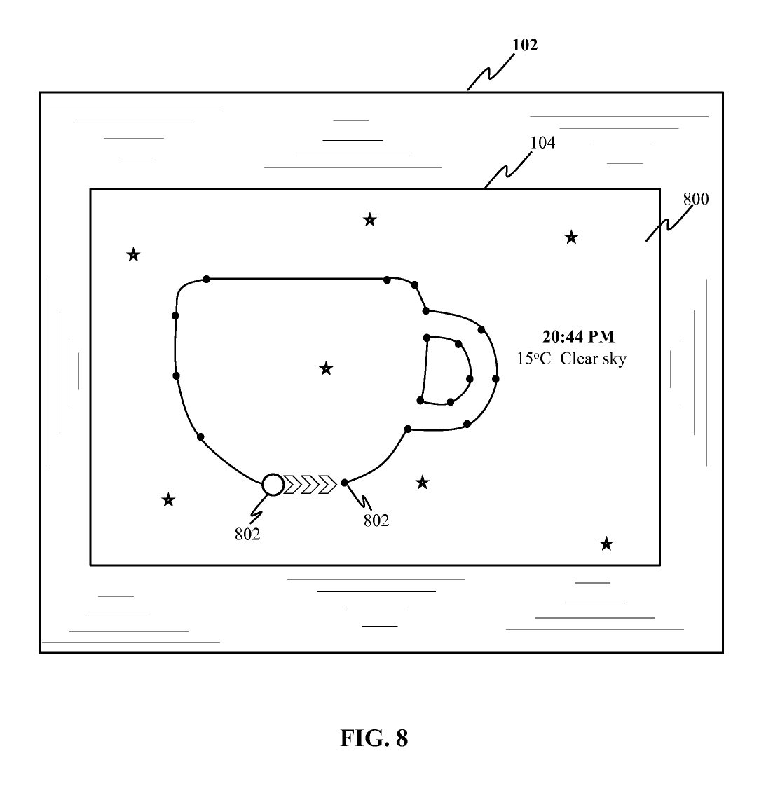

FIG. 8 illustrates an example lock screen 800 on the user interface 104, in accordance with an embodiment. In the instant embodiment, the lock screen displayed on the user interface allows the user to unlock the screen by connecting plurality of points 802. Further, the user is allowed to access the application tray 202. In an embodiment, the lock screen 800 can be configured to display one or more themes depending on various factors, including but not limited to, time of the day, holidays, special events, location of the devices, nature of the business, temperature, weather report, user details and news, among others. In an embodiment, the themes displayed on the lock screen 800 can include one or more animations, time , date, news, user details, weather updates, time since the device is locked, one or more images, one or more advertisements, special offers, business names, products and services, among other.

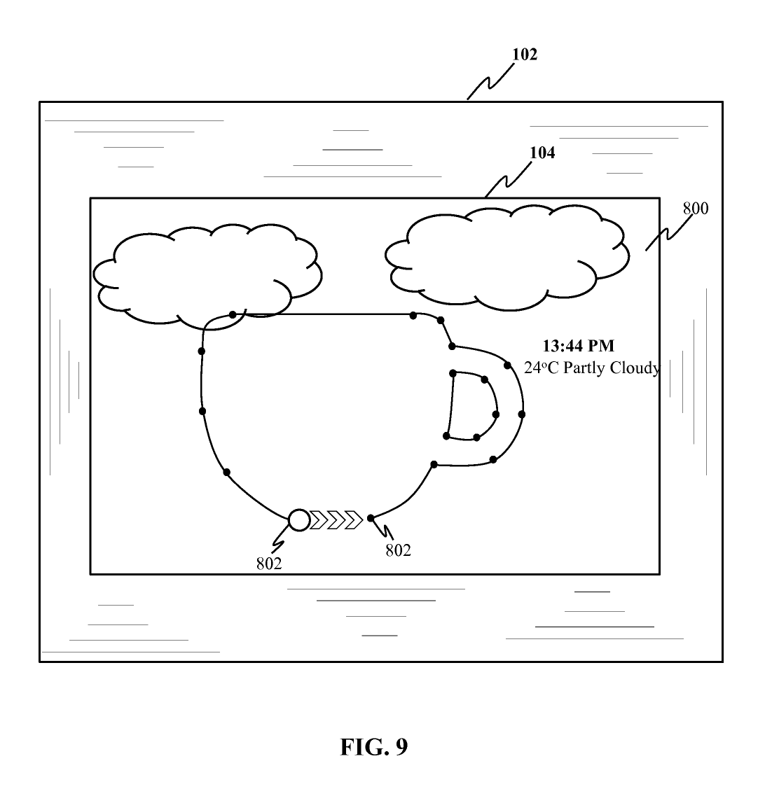

FIG. 9 illustrates another example lock screen 800 on the user interface 104, in accordance with an embodiment. The instant embodiment displays a theme based on the time of the day and the weather report along with the points 802 to unlock the locked screen on the user interface 104. In an embodiment the display device 102 is comprised of one or more processors, a memory associated with the one or more processors and a display for user interface. In another embodiment, the display device can further include one or more interfaces for local area network or wide area network and a bus connecting one or more components of the display device 102.

In an embodiment the display for user interface 104 can include any know display technology including but not limited to Liquid Cristal Display (LCD), Light Emitting Diode (LED) and Plasma, among other technologies. In an embodiment the one or more processors can use technologies known in the art, including but not limited to multi-core processors and graphics processors, among others.

A system is provided for enabling access to one or more applications on a device. The system includes a plurality of application trays, wherein each of the application trays is configured to accommodate one or more icons corresponding to applications, hide all the icons accommodated in the application tray; and display at least one icon accommodated in the application tray upon receiving an input from a user. In some embodiments, each of the application trays is configured to enable changing the size of the application tray. In some embodiments, each of the application trays is configured to enable navigation through the application tray.

In some embodiments, each of the application trays is configured to enable a user to login by providing authentication credentials. In some embodiments, the icons corresponding to the user are displayed in the application tray after the user successfully logs in. In some embodiments, the user accesses icons corresponding to applications through the application tray across plurality of devices that are associated with each other. In some embodiments, the application tray is configured to receive input to execute an application. In some embodiments, the input to execute the application is dragging the respective icon out of the application tray.

In some embodiments, the user is allowed to shrink one or more executed applications. In some embodiments, the user is allowed to group one or more executed applications. In some embodiments, the user is allowed to group one or more executed applications by drawing a boundary around the one or more applications. In some embodiments, the user is allowed to move the executed applications on the user interface. In some embodiments, the user is allowed to lock a user interface of the device through the application tray. In some embodiments, the user is allowed to lock a part of the user interface through the application tray.

In some embodiments, the device is configured to display a lock screen on the user interface, when the user interface is locked. In some embodiments, the lock screen includes one or more themes. In some embodiments, the themes are based on at least one of time, holidays, special events, location of the devices, nature of business, date, temperature, weather report, user details and news. In some embodiments, the themes include one or more animations, time , date , news, user details, weather updates, time since the device is locked, one or more images, one or more advertisements, special offers, business names, products and services. In some embodiments, the user can unlock the user interface of the device by connecting plurality of points on the user interface. In some embodiments, the user is allowed to lock the application tray and one or more executed applications from the application tray.

In some embodiments, the system is further configured to indicate in the application tray, applications that have been executed in the device. In some embodiments, at least one of the application trays is configured to accommodate icons in one or more rows and columns. In some embodiments, each of the applications trays are configured to enable a user to perform at least one of search, modify, organize, group, update and delete one or more applications.

A method is provided for enabling access to one or more applications on a device. The method includes providing a plurality of application trays in the device, wherein each of the application trays is configured to accommodate one or more icons corresponding to applications, hide all the icons accommodated in the application tray, and display at least one icon accommodated in the application tray upon receiving an input from a user. In some embodiments, the method further includes enabling of changing the size of the application trays. In some embodiments, the method further includes enabling of navigation through the application trays. In some embodiments, the method further includes enabling a user to login by providing authentication credentials. In some embodiments, the method further includes displaying of icons corresponding to the user in the application tray after the user successfully logs in.

In some embodiments, the method further includes enabling the user to access icons corresponding to applications through the application tray across plurality of devices that are associated with each other. In some embodiments, the method further includes configuring the application tray to receive input to execute an application. In some embodiments, the input to execute the application is dragging the respective icon out of the application tray. In some embodiments, the method further includes allowing the user to shrink one or more executed applications. In some embodiments, the method further includes allowing the user to group one or more executed applications. In some embodiments, the method further includes allowing the user to group one or more executed applications by drawing a boundary around the one or more applications.

In some embodiments, the method further includes allowing the user to move the executed applications on the user interface. In some embodiments, the method further includes allowing the user to lock a user interface of the device through the application tray. In some embodiments, the method further includes allowing the user to lock a part of the user interface through the application tray. In some embodiments, the device is configured to display a lock screen on the user interface, when the user interface is locked. In some embodiments, the lock screen includes one or more themes. In some embodiments, the themes are based on at least one of time of the day, holidays, special events, location of the devices, nature of business, date, temperature, weather report, user details and news.

In some embodiments, the themes include one or more animations, time , date , news, user details, weather updates, time since the device is locked, one or more images, one or more advertisements, special offers, business names, products and services. In some embodiments, the method further includes allowing the user to unlock the user interface of the device by connecting plurality of points on the user interface. In some embodiments, the method further includes allowing the user to lock the application tray and one or more executed applications from the application tray. In some embodiments, each of the applications trays are configured to enable a user to perform at least one of search, modify, organize, group, update and delete one or more applications. In some embodiments, the method further includes indicating in the application tray, applications that have been executed in the device. In some embodiments, the method further includes accommodating icons in one or more rows and columns in at least one of the application trays.

The processes described above is described as a sequence of steps, this is solely for the sake of illustration. Accordingly, it is contemplated that some steps may be added, some steps may be omitted, the order of the steps may be re-arranged, or some steps may be performed simultaneously. The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. In a multiuser touch sensitive screen display device including a touch sensitive display screen capable of receiving touch sensitive inputs from a plurality of users and displaying a plurality of application trays each tray having a tray handle, each tray associated with one of the plurality of users and each tray containing a plurality of application icons representing corresponding application programs, each application icon, when activated by one of the plurality of users, initiates an execution of a corresponding application program, wherein the multiuser touch sensitive screen display device can display a plurality of windows each window providing a user interface for a user to interact with an application program and wherein, when an application tray is hidden from view on the display screen, only the tray handle of the application tray is displayed on the display screen, a method for enabling one or more of the plurality of users to access a plurality of application programs contained in one or more of the application trays, the method comprising:
receiving a first touch sensitive input from one of the plurality of users for accessing one of the plurality of application trays associated with the one user if the selected application tray associated with the user is hidden from view on the display screen, wherein the first touch sensitive input includes the user's pulling the associated application tray handle until the selected application tray becomes fully visible on the display screen;
displaying a plurality of application icons contained in the associated application tray;
receiving a second touch sensitive input from the user for starting a selected application program, wherein the second touch sensitive input includes one of the user's pulling out of the application tray an application icon associated with the selected application program or the user's touching the associated application icon; and
in response to the second touch sensitive input, generating and displaying a window for providing a user interface for the selected application program, wherein the window is used to received user inputs and display outputs for a running instance of the selected application.

2. The method of claim 1, wherein the one or more of the plurality of users can simultaneously access the plurality of application programs contained in the one or more of the application trays.

3. The method of claim 1, wherein each of the plurality of application trays is capable of containing more application icons that the each tray can display all at once.

4. The method of claim 1, wherein each of the plurality of application tray includes an application search tool.

5. The method of claim 1, wherein each of the plurality of application tray includes a plurality of tray pages, each page containing a set of application icons and wherein a user can move from one page to another page using one of a scrolling gesture or a sliding gesture on each page.

6. The method of claim 1, wherein the first touch sensitive input including the user's pulling of the associated application tray handle animates pulling open a handle of a virtual drawer containing the plurality of application icons.

7. The method of claim 1, wherein each of the plurality of windows has an application handle and is capable of being minimized on the display screen in response to a user's touching the application handle.

8. The method of claim 1, further includes generating a group icon containing at least one application icon by drawing a boundary around the at least one application icon, wherein each of the plurality of application tray is capable of including one or more group icons.

9. The method of claim 8, further including releasing the at last one application icons from the group icon by providing a gesture input including one of a gesture of cutting across the group icon or a gestures of crossing the group icon.

10. The method of claim 1, further including displaying a lock screen having a plurality of dots and a background image, wherein a user can unlock the lock screen by connecting at least some of the plurality of dots and wherein the background image changes in accordance with at least one of date, time and weather of a day.
